(19) United States
(12) Patent Application Publication
(10) Pub. No.: US 2022/0022093 A1
(43) Pub. Date: Jan. 20, 2022

(54) METHOD AND APPARATUS FOR BUFFER STATUS REPORT ENHANCEMENT

(71) Applicant: Telefonaktiebolaget LM Ericsson (publ), Stockholm (SE)

(72) Inventors: Jinhua LIU, BEIJING (CN); Min WANG, LULEÅ (SE)

(21) Appl. No.: 17/311,290

(22) PCT Filed: Sep. 29, 2019
(86) PCT No.: PCT/CN2019/109074

§ 371 Date: Jun. 4, 2021

(30) Foreign Application Priority Data
Dec. 7, 2018 (CN) PCT/CN2018/119744

(51) Int. Cl. H04W 28/02

(52) U.S. Cl. CPC H04W 28/0278

(57) ABSTRACT

A method for reporting buffer status is proposed. The method which may be performed by a radio device includes detecting a trigger event of reporting buffer status of a logical channel group for the radio device to a network node. The method may further include triggering a buffer status report indicating the buffer status of the logical channel group, in response to the detected trigger event. The buffer status report may be allowed not to indicate buffer status of one or more other logical channel groups for the radio device, for which logical channel groups no event occurs to trigger reporting of buffer status.

### FIELD OF THE INVENTION

The present disclosure generally relates to communication networks, and more specifically, to scheduling transmission in a communication network.

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performance. With the rapid development of networking and communication technologies, wireless communication networks such as long-term evolution (LTE) and new radio (NR) networks are expected to achieve high traffic capacity and end-user data rate with lower latency. In order to meet data transmission requirements, a radio device can send a scheduling request (SR) to a wireless communication network to request radio resource for data transmission. The wireless communication network can perform a scheduling procedure according to a buffer status report (BSR) from the radio device. BSR configuration may affect quality of service and utilization of radio resource. Thus, it is desirable to enhance BSR configuration efficiently.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

In a wireless communication network, a radio device can use a BSR in uplink transmission to notify a serving network node how many data are queued in a transmit buffer at the radio device. Based at least in part on the received BSR, the serving network node can perform uplink scheduling for the radio device. The introduction of new system structures and access technologies such as integrated access backhaul (IAB) in the network may bring challenges on resource allocation and transmission scheduling. For example, the logical channel identifier (LCID) space may need to be extended so as to support more logical channels (LCHs) in a backhaul link. Correspondingly, the logical channel group identifier (LCG ID) space may also need to be extended. In this case, LCID and LCG ID fields in the existing BSR medium access control (MAC) control element (CE) may not be applicable for a longer LCID and more LCGs. On the other hand, the conventional BSR trigger per MAC entity basis may significantly increase resource overhead especially with the extension of LCG ID space. Therefore, it may be desirable to implement BSR enhancement.

The present disclosure proposes a solution of BSR enhancement in a communication network, which can enable a BSR to be triggered per LCG for a radio device, such as a user equipment (UE) or an IAB node (IAB-N), and optionally transmitted to a network node in a configurable format, so that the network node can be informed of buffer status of an LCG for the radio device in a more efficient way.

According to a first aspect of the present disclosure, there is provided a method performed by a radio device. The method may comprise detecting a trigger event of reporting buffer status of an LCG for the radio device to a network node. The method may further comprise triggering a BSR indicating the buffer status of the LCG, in response to the detected trigger event. The BSR may be allowed not to indicate buffer status of one or more other LCGs for the radio device, for which LCGs no event occurs to trigger reporting of buffer status.

In accordance with an exemplary embodiment, the method according to the first aspect of the present disclosure may further comprise: indicating buffer status of at least one of the one or more other LCGs in the BSR, in response that there is free radio resource available for reporting the buffer status of the at least one of the one or more other LCGs.

In accordance with an exemplary embodiment, the triggering of the BSR may comprise selecting, from one or more candidate formats, a format of the BSR based at least in part on at least one of a size of an LCG ID space; a service type; a bear type; a number of LCGs for which the corresponding buffer status is to be reported to the network node; an amount of information for indicating buffer status of an LCG for which the corresponding buffer status is to be reported to the network node; and an amount of radio resource available for the radio device.

In accordance with an exemplary embodiment, the one or more candidate formats may comprise a first format which is configurable to report buffer status of a single LCG by using at least one of: an extendible LCID field; an extendible LCG ID field; and an extendible buffer status field.

Alternatively or additionally, the one or more candidate formats may comprise a second format which is configurable to report buffer status of up to a first number of LCGs by using at least one of: an extendible LCID field; up to the first number of extendible LCG ID fields; and up to the first number of extendible buffer status fields. The first number may be equal to or larger than two. In accordance with an exemplary embodiment, the second format may be configurable to allow that the number of the LCG ID fields in the BSR is equal to or larger than the number of the buffer status fields.

Alternatively or additionally, the one or more candidate formats may comprise a third format which is configurable to report buffer status of up to a second number of LCGs by using at least one of: an extendible LCID field; up to the second number of status presence fields indicating for which LCGs the corresponding buffer status is reported or is not reported; and up to the second number of buffer status fields. The second number may be determined based at least in part on a maximum number of LCGs configured for the radio device. In accordance with an exemplary embodiment, the third format may be configurable to allow that the number of the status presence fields in the BSR is equal to or larger than the number of the buffer status fields.

In accordance with an exemplary embodiment, the one or more candidate formats may be preconfigured for the radio device by the network node. Alternatively or additionally, at least a part of the one or more candidate formats may be predefined locally at the radio device.

In accordance with an exemplary embodiment, the triggering of the BSR may further comprise: generating the BSR, based at least in part on the selected format of the BSR; and transmitting the BSR to the network node.

In accordance with an exemplary embodiment, the trigger event may comprise an event related to a BSR timer configured for the LCG. Alternatively or additionally, the trigger event may comprise other potential event which can trigger the BSR per LCG according to a predetermined configuration.

In accordance with an exemplary embodiment, the method according to the first aspect of the present disclosure may further comprise: indicating buffer status of at least one of the one or more other LCGs in another BSR, in response that there is free radio resource available for reporting the buffer status of the at least one of the one or more other LCGs; and transmitting to the network node the another BSR in a different control element from a control element e.g., BSR MAC CE) carrying the BSR.

In accordance with an exemplary embodiment, the radio device may comprise a terminal device, an IAB-N, a node B (NB), a transmission point, a relay node, or any other device which is able to trigger a BSR per LCG by performing the method according to the first aspect of the present disclosure.

According to a second aspect of the present disclosure, there is provided an apparatus which may be implemented as a radio device. The apparatus may comprise one or more processors and one or more memories comprising computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus such as a radio device. The apparatus may comprise a detecting unit and a triggering unit. In accordance with some exemplary embodiments, the detecting unit may be operable to carry out at least the detecting step of the method according to the first aspect of the present disclosure. The triggering unit may be operable to carry out at least the triggering step of the method according to the first aspect of the present disclosure.

According to a fifth aspect of the present disclosure, there is provided a method performed by a network node. The method may comprise receiving a BSR being triggered for an LCG from a radio device. The BSR indicates buffer status of the LCG for the radio device. The method may further comprise updating a buffer status record of the LCG for the radio device at the network node, based at least in part on the BSR. The BSR may be allowed not to indicate buffer status of one or more other LCGs for the radio device, for which LCGs no event occurs to trigger reporting of buffer status.

In accordance with an exemplary embodiment, the updating of the buffer status record may comprise: determining which of one or more candidate formats is a format of the BSR, based at least in part on the BSR; and obtaining the buffer status indicated by the BSR to update the buffer status record, according to the determined format of the BSR. Optionally, the one or more candidate formats may be preconfigured by the network node and/or the radio device.

In accordance with an exemplary embodiment, the BSR may be triggered in response to an event which is related to a BSR timer configured for the LCG.

In accordance with an exemplary embodiment, the method according to the fifth aspect of the present disclosure may further comprise: updating a buffer status record of at least one of the one or more other LCGs for the radio device at the network node, based at least in part on the BSR. The BSR may indicate buffer status of the at least one of the one or more other LCGs.

In accordance with an exemplary embodiment, the method according to the fifth aspect of the present disclosure may further comprise: receiving, from the radio device, another BSR in a different control element from a control element carrying the BSR. Said another BSR may indicate buffer status of at least one of the one or more other LCGs.

In accordance with an exemplary embodiment, the method according to the fifth aspect of the present disclosure may further comprise: updating a buffer status record of the at least one of the one or more other LCGs for the radio device at the network node, based at least in part on the another BSR.

According to a sixth aspect of the present disclosure, there is provided an apparatus which may be implemented as a network node. The apparatus may comprise one or more processors and one or more memories comprising computer program codes. The one or more memories and the computer program codes may be configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus such as a network node. The apparatus may comprise a receiving unit and an updating unit. In accordance with some exemplary embodiments, the receiving unit may be operable to carry out at least the receiving step of the method according to the fifth aspect of the present disclosure. The updating unit may be operable to carry out at least the updating step of the method according to the fifth aspect of the present disclosure.

According to a ninth aspect of the present disclosure, there is provided a method implemented in a communication system which may include a host computer, a base station and UE. The method may comprise providing user data at the host computer. Optionally, the method may comprise, at the host computer, initiating a transmission carrying the user data to the UE via a cellular network comprising the base station which may perform any step of the method according to the fifth aspect of the present disclosure.

According to a tenth aspect of the present disclosure, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the method according to the fifth aspect of the present disclosure.

According to an eleventh aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the method according to the first aspect of the present disclosure.

According to a twelfth aspect of the present disclosure, there is provided a communication system including a host computer. The host computer may comprise processing circuitry configured to provide user data, and a communication interface configured to forward user data to a cellular network fir transmission to a UE. The UE may comprise a radio interface and processing circuitry. The UE's processing circuitry may be configured to perform any step of the method according to the first aspect of the present disclosure.

According to a thirteenth aspect of the present disclosure, there is provided a method implemented in a communication system which may include a host computer, a base station and a UE. The method may comprise, at the host computer, receiving user data transmitted to the base station from the UE which may perform any step of the method according to the first aspect of the present disclosure.

According to a fourteenth aspect of the present disclosure, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the method according to the first aspect of the present disclosure.

According to a fifteenth aspect of the present disclosure, there is provided a method implemented in a communication system which may include a host computer, a base station and a UE. The method may comprise, at the host computer, receiving, from the base station, user data originating from a transmission which the base station has received from the UE. The base station may perform any step of the method according to the fifth aspect of the present disclosure.

According to a sixteenth aspect of the present disclosure, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the method according to the fifth aspect of the present disclosure.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1 is a diagram illustrating an example of NR network IAB capability according to some embodiments of the present disclosure;

FIGS. 2A-2B are diagrams illustrating examples of BSR formats according to some embodiments of the present disclosure;

FIGS. 3A-3C are diagrams illustrating examples of BSR formats according to some embodiments of the present disclosure;

FIG. 4 is a flowchart illustrating a method according to some embodiments of the present disclosure;

FIG. 5 is a flowchart illustrating another method according to some embodiments of the present disclosure;

FIG. 6 is a block diagram illustrating an apparatus according to some embodiments of the present disclosure;

FIG. 7 is a block diagram illustrating another apparatus according to some embodiments of the present disclosure;

FIG. 8 is a block diagram illustrating yet another apparatus according to some embodiments of the present disclosure;

FIG. 9 is a block diagram illustrating a telecommunication network connected via an intermediate network to a host computer in accordance with some embodiments of the present disclosure;

FIG. 10 is a block diagram illustrating a host computer communicating via a base station with a UE over a partially wireless connection in accordance with some embodiments of the present disclosure;

FIG. 11 is a flowchart illustrating a method implemented in a communication system, in accordance with an embodiment of the present disclosure;

FIG. 12 is a flowchart illustrating a method implemented in a communication system, in accordance with an embodiment of the present disclosure;

FIG. 13 is a flowchart illustrating a method implemented in a communication system, in accordance with an embodiment of the present disclosure; and

FIG. 14 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a radio device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network node” refers to a network device in a communication network via which a radio device accesses to the network and receives services therefrom. The network node may refer to a base station, an access point (AP), a multi-cell/multicast coordination entity (MCE), a controller or any other suitable device in a wireless communication network. The base station may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a radio device access to a wireless communication network or to provide some service to a radio device that has accessed to the wireless communication network.

The term “radio device” refers to a terminal device, an IAB node (IAB-N), a transmission point, a relay node or any communication device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

Wireless communication networks are widely deployed to provide various telecommunication services such as voice, video, data, messaging and broadcasts. To meet dramatically increasing network requirements on traffic capacity and data rates, one interesting option for communication technique development is to allow a wireless communication network such as NR configured with integrated access backhaul (IAB) capability.

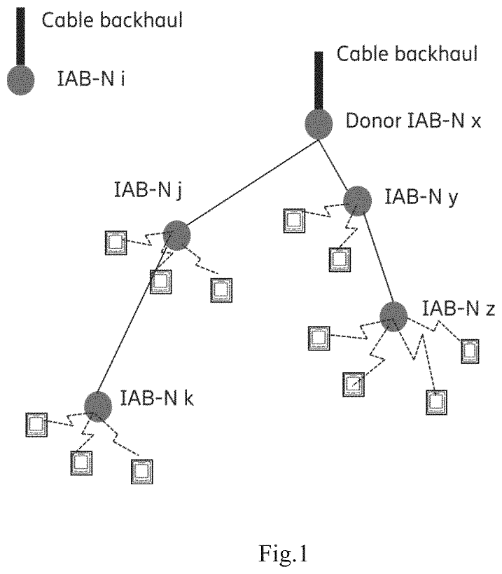

FIG. 1 is a diagram illustrating an example of NR network with IAB capability according to some embodiments of the present disclosure. For an NR network with IAB capability, an AP (such as IAB-N k and IAB-N z shown in FIG. 1) can setup a radio connection to another AP (such as IAB-N j and IAB-N y shown in FIG. 1) in order to reach a donor AP (such as IAB-N x shown in FIG. 1) which has a wireline backhaul. An AP in this network scenario is also referred to as an IAB-N. The radio connection between IAB-Ns is referred to as a wireless backhaul or a self-backhaul. As shown in FIG. 1, the donor IAB-N x has a cable backhaul to a gateway, IAB-N y acts as a bridge node between IAB-N x and IAB-N z. In this case, IAB-N y is referred to as the parent IAB-N of IAB z and IAB-N z is referred to as the child IAB-N of IAB-N y. another branch, IAB-N k is connected to IAB-N j, and IAB-N j is connected to IAB-N x. An IAB-N such as IAB-N i, IAB-N x, IAB-N y, IAB-N z, IAB-N k and IAB-N j may also have UEs connected to the IAB-N. It will be appreciated that there may be other network scenarios where more or less donor IAB-N(s) can be deployed in the network to implement different system structures, although FIG. 1 only shows two donor IAB-Ns (IAB-N i and IAB-N x) in the network where one donor IAB-N has the child IAB-Ns and the other has no child IAB-N.

For an IAB-N, there may be three types of links, for example, including upstream links to/form the parent IAB-N, downstream link to/from the child IAB-N, and a number of downlinks/uplinks to/from the served UEs for access the network. The first two types of links are also referred to as backhaul links. The network with IAB capability (which is also referred to as IAB network for simplicity) is supposed to handle the resource allocation among various links for a number of IAB-Ns and their served UEs in the network. There may be different types of resource allocation strategies, for instance, a distributed resource allocation mechanism and a centralized resource allocation mechanism. According to the distributed resource allocation mechanism, each IAB-N can allocate resources among the three types of links by itself with/without coordination between IAB-Ns. For the centralized resource allocation mechanism, a certain control function unit (e.g. a unit located in the donor IAB-N) can configure the resource allocation according to the reported information from the child IAB-Ns. In accordance with an exemplary embodiment, an IAB-N may schedule the connected UEs and/or its child IAB-Ns while this IAB-N may also be scheduled by its parent IAB-N. A SR/BSR based scheduling procedure may be supported by the IAB network.

A radio device such as UE can use a SR to request uplink shared channel (UL-SCH) resources for new data transmission. A SR can be transmitted via a physical uplink control channel (PUCCH), or a random access channel (RACH) if PUCCH resource is not available. Upon reception of the SR from a UE, the serving gNB knows that the UE has data to transmit in uplink. In an uplink MAC packet data unit (PDU), the UE may include a BSR to notify the gNB how many bits are queued in the transmit buffer. Upon reception of the BSR, the serving gNB can perform further scheduling procedures for the UE, for example, comprising various link adaptation procedures such as prioritization of users, resource allocation, modulation and coding scheme (MCS) selection, rank adaptation and sounding reference signal (SRS) configuration/activation/deactivation/release, etc.

The BSR may be carried in a physical uplink shared channel (PUSCH) using a BSR MAC CE. The BSR formats may be identified by MAC PDU sub-headers with LCIDs. For example, BSR MAC CEs may support a short BSR format with fixed size, a long BSR format with variable size, a short truncated BSR format with fixed size, and a long truncated BSR format with variable size. In the short or short truncated BSR format, buffer size levels may be indicated by using a 5-bit buffer size field. In the long or long truncated BSR format, buffer size levels may be indicated by using an 8-bit buffer size field.

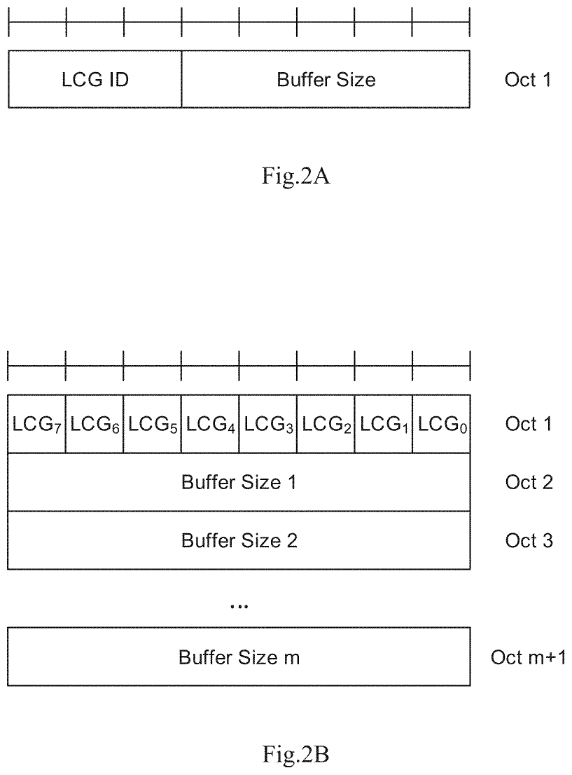

FIGS. 2A-2B are diagrams illustrating examples of BSR formats according to some embodiments of the present disclosure. For simplicity, FIG. 2A only shows a 3-bit LCG ID field and a 5-bit buffer size field for the short BSR and short truncated BSR MAC CE, and FIG. 2.B only shows eight 1-bit LCGi (i=0, 1, . . . , 7) fields in one octet and in 8-bit buffer size fields for the long BSR and long truncated BSR MAC CE. For the short BSR format, the LCG ID field as shown in FIG. 2A can use 3 bits to identify the LCG whose buffer status is being reported. For the long BSR format, the LCGi field can use 1 bit to indicate the presence of the buffer size field for LCG i. For example, the LCGi field set to “1” indicates that the buffer size field for LCG i is reported. The LCGi field set to “0” indicates that the buffer size field for LCG i is not reported. For the long truncated BSR format, the LCGi field indicates whether LCG i has data available. For example, the LCGi field set to “1” indicates that LCG i has data available. The LCGi field set to “0” indicates that LCG i has no data available.

The buffer size field can identify the total amount of data available according to the data volume calculation procedure across all LCHs of an LCG after the MAC PDU has been built (e.g., after the LCH prioritization procedure, which may result the value of the buffer size field to zero). The amount of data can be indicated in a number of bytes. The size of the radio link control (RLC) and MAC headers may not be considered in the buffer size computation. As shown in FIGS. 2A-2B, the length of the buffer size field for the short BSR format and the short truncated BSR format is 5 bits, and the length of the buffer size field for the long BSR format and the long truncated BSR format is 8 bits. For the long BSR format and the long truncated BSR format, the buffer size fields may be included in ascending order based on LCGi. For the long truncated BSR format, the number of buffer size fields included may be maximized, while not exceeding the number of padding bits. It can be appreciated that the number of the buffer size fields in the long BSR for mat and the long truncated BSR format can be zero.

As mentioned previously, the SR/BSR based scheduling procedure may be performed in the IAB network, for example, for a UE or an IAB-N. For the IAB network, some 3GPP agreements with respect to LCID extension may impact the BSR. For example, the IAB network can support many-to-one (M:1) and one-to-one (1:1) bearer mappings in a design since both mapping options provide benefits in different deployments and traffic scenarios. The design allows many-to-one and one-to-one bearer mappings to be used at the same time. The unified design can support the hop-by-hop automatic repeat request (ARQ) and the end-to-end ARQ is not excluded for one-to-one mapping. The unified design can address LCID-space and LCG-space limitations to support fine-granular quality of service (QoS) for a significantly large number of bearers.

The support of M:1 bearer mapping (e.g., M UE bearers to 1 backhaul bearer) is beneficial to enable bearer aggregation of services from different UEs which have similar QoS requirements, while 1:1 bearer mapping (e.g., 1 UE bearer to 1 backhaul RLC channel) is beneficial to achieve finer QoS granularity when services of different UEs have differentiated QoS requirements. To support this, the LCID space is extended so that more than 64 LCHs can be supported in a backhaul link. As a consequence of LCID extension, the LCG ID space may also need to be extended. In this case, the 6 bit LCID and 3 bit LCG ID in the existing MAC CEs such as the short BSR MAC CE may not be sufficient. Both short and long BSR MAC CE formats may need to be updated accordingly, in order to support a BSR for more LCGs and a longer LCID field.

As another aspect, in the existing short BSR MAC CE, there is a single byte payload including 3 bits of LCG (maximum 8 LCGs) ID and 5 bits of a buffer size level indication. If the size of the LCG ID field is extended, e.g., to 4 bits or 5 bits, there would be too few bits left for the buffer size field which may then not be able to give an accurate BSR. Therefore, simply increasing LCG ID bits may not be feasible in this case. In a further aspect, the long BSR MAC CE format may also need to be improved to enable a long BSR for more than 8 LCGs.

In order to enhance the configuration of BSR and improve the resource efficiency of a communication network such as IAB network, the present disclosure according to some exemplary embodiments proposes a new BSR triggering mechanism which considers the LCID and/or LCG ID extension for the network. In addition, some new BSR MAC CE formats (which are also referred to as BSR formats for easy of illustration) are also proposed to support a BSR for more LCGs in a flexible way.

It can be appreciated that although some embodiments are described with respect to a BSR in an IAB network, the proposed solution is also applicable to other non-IAB scenarios where there may be a change on the BSR triggering mechanism and/or the BSR format due to extension of LCH ID or LCG ID space. The proposed solution can enable LCG specific BSR triggering. On the other hand, according to the proposed solution, a BSR MAC CE format may be configurable and a radio device such as UE and IAB-N can select or determine the BSR MAC CE format adaptively.

According to the conventional BSR triggering mechanism in LTE and NR, a BSR may be triggered as follows:
a regular BSR is triggered upon either arrival of new data in an empty UE buffer, or arrival of the new data with higher priority levels;
padding BSR is triggered if the number of padding bits is equal to or larger than the size of the BSR MAC CE plus its sub-header;
a regular BSR is triggered if retxBSR-timer is expired while at least one of the LCHs which belong to an LCG contains uplink data; or
a periodic BSR is triggered if periodicBSR-timer is expired.

The above mechanism makes a BSR triggered per MAC entity basis, not per LCG, meaning that a transmitted BSR at any time always needs to carry the buffer status for all LCGs with data.

The proposed solution according to some exemplary embodiments defines LCG specific BSR triggering in a network such as IAB network. It is motivated by a fact that the simultaneous BSR overhead may be significantly increased especially when many-to-one bearer mapping is applied in an IAB-N. In a backhaul link, if an LCG specific BSR triggering is allowed, a BSR triggering condition can be configured per LCG. In this case, a BSR MAC CE may only carry the buffer status for the LCGs which have triggered BSR events. For another LCG having non-empty buffer but without a triggered BSR event, its buffer status may not be reported in the BSR MAC CE to be transmitted. However, if there are still free resources available after including, in the BSR MAC CE, the buffer status of the LCGs which have triggered BSR events, a radio device such as a UE or an IAB-N may be allowed to include the buffer status of other LCGs into the BSR MAC CE.

In accordance with some exemplary embodiments, upon reception of an uplink grant from a network node such as a gNB, a radio device such as a UE or an IAB-N may have more resources left for service data after inclusion of the BSR MAC CE (which may only carry the buffer status for the LCGs which have triggered BSR events) in a MAC PDU. Further, after inclusion of all necessary service data in the MAC PDU, if there are still free resources available, the buffer status information for other LCGs (which have non-empty buffers but without the triggered BSR events) can be included, for example, in a separated BSR MAC CE following a decreasing order of the LCG priorities in the current MAC PDU. Upon reception of a BSR, the gNB can only update a record of the buffer status of the LCGs whose buffer status is reported in the received BSR.

In accordance with some exemplary embodiments, multiple BSR MAC CE formats may be applicable based at least in part on the possible extension of the LCID space. A network node can configure which BSR MAC CE format(s) to be used for a wireless link of a radio device (e.g., a backhaul link of an IAB-N or an uplink of a UE). A predefined LCID can be used for the configured BSR MAC CE format. In addition to the existing BSR MAC CE formats, some new BSR MAC CE formats can be defined as candidate BSR formats for transmitting BSRs from the radio device to the network node in accordance with exemplary embodiments.

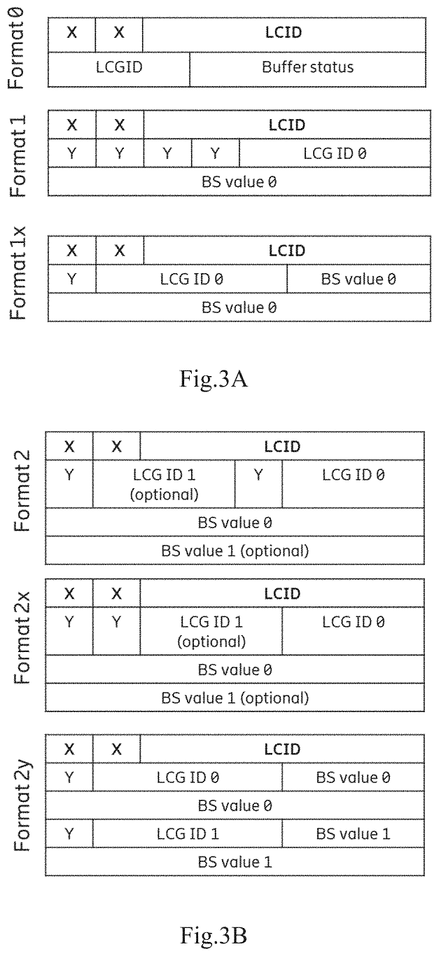

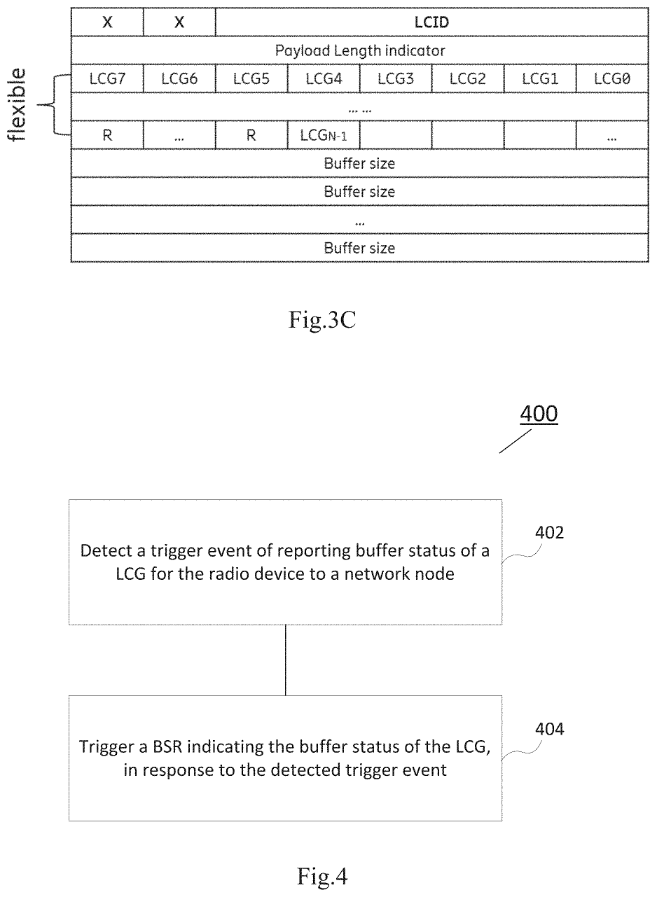

FIGS. 3A-3C are diagrams illustrating examples of BSR formats according to some embodiments of the present disclosure. For simplicity, FIGS. 3A-3C merely schematically depict exemplary MAC sub-header and the payload for the MAC CE in various BSR formats. FIGS. 3A-3B illustrate short BSR MAC CEs for a single LCG and up to 2 LCGs, respectively, and FIG. 3C illustrates a long BSR MAC CE for multiple LCGs. In FIGS. 3A-3C, ‘X’ bit can be either R bit or the extended bit of the LCID field, and ‘Y’ bit can be either ‘R’ bit or the extended bit of the LCG ID field. The LCG ID per LCH ID space may be configured per radio device. It can be recognized that the field names and the number of bits in a field shown in FIGS. 3A-3C are just as examples, and more or less alternative fields with different names and number of bits may be included in the candidate BSR formats according to the embodiments of the present disclosure.

Among three short BSR formats as shown in FIG. 3A, Format 0 uses two bytes to report buffer status for a single LCG, and Format 1 and Format 1x use three bytes to report buffer status for a single LCG. For Format 0, the LCID field has 6 bits, the LCG ID field has 3 bits, and the buffer size/buffer status (BS) field has 5 bits to indicate a buffer size level which can represent buffer status. This format is similar to the existing short BSR MAC CE format, and the existing buffer size level mapping table with 32 entries can be used. Format 0 has the smallest size among the candidate BSR formats as shown in FIGS. 3A-3C, but it only supports up to 8 LCGs and the buffer size level granularity is the worst. For Format 1 as shown in FIG. 3B, the LCID field has 6 bits, the LCG ID field has 4 bits, and the BS field has 8 bits. The existing buffer size level mapping table with 256 entries can be used in this format. Optionally, there may be some bits such as ‘X’ bit and ‘Y’ bit can be reserved for future usage, or be used to extend the current field. For Format 1x as shown in FIG. 3C, the LCID field has 6 bits, the LCG ID field has 4 bits, and the BS field is increased to more than 8 bits (e.g., 11 bits). This format can support better buffer size level granularity than Format 0 and Format 1, while requiring a new buffer size level mapping table.

Among three short BSR formats as shown in FIG. 3B, Format 2 and Format 2x use 4 bytes to report buffer status fir up to two LCGs, and Format 2y uses 5 bytes to report buffer status for up to two LCGs. For Format 2 and Format 2x, the LCID field has 6 bits, the LCG ID field per LCG has 3 bits, and the BS field per LCG has 8 bits to indicate a buffer size level per LCG. One LCG among up to 16 LCGs can be supported with Format 2 and Format 2x. In accordance with some exemplary embodiments, ‘Y’ bit can be used to extend the space for LCG ID, for example, according to the design in Format 2 or Format 2x. The existing buffer size mapping table of 256 entries can be used in the two formats. According to an exemplary embodiment, the LCG ID field and/or the BS field may be configured as an optional field in the BSR, as shown in FIG. 3B, so as to save some bytes for a BSR. For Format 2y, the LCID field has 6 bits, the LCG ID field per LCG has 4 bits, and the BS field per LCG has more than 8 bits (e.g., 11 bits) to indicate a buffer size level per LCG. This format can have better buffer size granularity than Formats 0, 1, 2 and 2x, but it requires a new buffer size level mapping table.

In accordance with sonic exemplary embodiments, Format 2, 2x or 2y also can be used to report buffer status for a single LCG. In this case, Format 2, 2x or 2y can be defined to keep the fixed length or the variable length. For the case of the variable length, the BS field corresponding to the field LCG ID 1 may appear only when the BSR is triggered for two LCGs. In this case, a special value of the field LCG ID 1 can be used to implicitly indicate the appearance of BS value 1. For instance, if LCG ID 1 is ‘00 . . . 0’, it means the field of BS value 1 does not appear, while the buffer status of LCG 0 is always carried in the BSR triggered for the LCG indicated in the field LCG ID 0.

In accordance with some exemplary embodiments, a long or long truncated BSR MAC CE format (such as Format 3 shown in FIG. 3C) may be used when there is buffer status to be reported for more than a predefined/preconfigured number of LCGs (e.g., three or more LCGs). As shown in FIG. 3C, Format 3 contains a 6-bit LCID field, two ‘X’ bits, an 8-bit payload length indicator, an LCG list, a plurality of buffer size fields, and optionally some ‘R’ bits. The buffer status presence of LCGs (e.g., from LCG0 to LCG_{N-1}, where N is the maximum number of LCGs for which buffer status is to be reported) can be indicated by the respective fields in the LCG list.

In order to avoid always using a large LCG list to indicate the buffer status presence of the maximum number of LCGs, the LCG space can be determined based at least in part on the maximum number of LCGs to be used for a wireless link and configurable per radio device such as UE or IAB-N. The maximum number of LCGs to be used for the wireless link can be configured explicitly by the network, or the radio device can derive the maximum number of LCGs to be used according to the configured LCG ID which has the largest value. For example, the length of the LCG list can be determined by the modular 8 arithmetic as follows:
Ceil (the configured maximum number of LCGs/8) bytes; or
Ceil (the derived maximum number of LCGs/8) bytes.

The LCG list can be configured flexibly according to the determined length. As such, the size of a long BSR format may be variable due to the flexible length of the LCG list.

In accordance with some exemplary embodiments, a set of long or long truncated BSR MAC CE formats with different LCG ID space length may be predefined at a radio device locally or configured by a network node. In this case, the radio device can select which BSR format is to be used, according to the configured or derived maximum number of LCGs.

In accordance with some exemplary embodiments, a radio device can adaptively select which BSR format is to be used among a set of preconfigured/predefined candidate BSR MAC CE formats (e.g., Formats 0, 1, 1x, 2, 2x, 2y and 3 as shown in FIGS. 3A-3C). One or more rules for selecting the proper BSR MAC CE format may be predefined locally at the radio device, or configured for the radio device by a network node. According to an exemplary embodiment, the selection of the BSR format may be performed base at least in part on an LCG ID field length, a service type, a bearer type, the number of LCGs for a BSR, etc. For instance, if there is only one LCG which triggers the BSR, one of Formats 0, 1 and 1x can be selected. If there are two LCGs which trigger the BSR, one of Formats 2, 2x and 2y can be selected. In the case that there are more than two LCGs which trigger the BSR, Format 3 can be used.

In an exemplary embodiment where buffer status is reported for a single LCG, if the LCG ID field does not exceed 3 bits, Format 0 can be used, otherwise Format 1 or Format 1x can be used. Alternatively or additionally, if the service for the radio device is low bit rate service possibly with critical QoS requirement, then Format 0 can be used. Format 1 may be used to achieve good granularity for an LCG with higher bit rate, while the uplink grant may be not sufficient for a long BSR format such as Format 3. Format 1x may be used for an LCG with even higher bit rate, and this format is useful especially when the many-to-one IAB bearer mapping option is applied.

The similar rules can be applied for selection of a BSR format among Formats 2, 2x and 2y to report buffer status for one or two LCGs. In the case of Formats 2, 2x or 2y being used, the radio device may have more than one LCG with triggered BSR event. According to the configured rules as described above, the radio device can determine the BSR MAC CE format within the candidate BSR formats when a BSR is triggered.

It is noted that some embodiments of the present disclosure are mainly described in relation to LTE or NR specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies may equally be utilized as long as exemplary embodiments described herein are applicable.

FIG. 4 is a flowchart illustrating a method 400 according to some embodiments of the present disclosure. The method 400 illustrated in FIG. 4 may be performed by a radio device or an apparatus communicatively coupled to the radio device. In accordance with an exemplary embodiment, the radio device may comprise a terminal device (such as a UE), an IAB-N, a NB, a transmission point, a relay node, etc. The radio device can use a BSR to inform a network node such as a base station (e.g., a gNB, an AP, etc.) of the amount of data which are queued in a transmit buffer at the radio device.

According to the exemplary method 400 illustrated in FIG. 4, the radio device can detect a trigger event of reporting buffer status of an LCG for the radio device to a network node, as shown in block 402. In accordance with some exemplary embodiments, the trigger event may comprise an event related to a BSR timer (e.g., retxBSR-timer and periodicBSR-timer) configured for the LCG. It can be realized that the trigger event may also comprise other potential event associated with a BSR being triggered per LCG.

In response to the detected trigger event, the radio device can trigger a BSR indicating the buffer status of the LCG, as shown in block 404. In accordance with some exemplary embodiments, the BSR may be allowed not to indicate buffer status of one or more other LCGs for the radio device, for which LCGs no event occurs to trigger reporting of buffer status. Optionally, the BSR may be allowed to alone indicate buffer status of the LCG(s) which triggers reporting of buffer status. According to an exemplary embodiment, in response that there is free radio resource available for reporting the buffer status of at least one of the one or more other LCGs, the radio device may indicate buffer status of the at least one of the one or more other LCGs in the BSR.

In accordance with some exemplary embodiments, the triggering of the BSR may comprise selecting, from one or more candidate formats, a format of the BSR based at least in part on any combination of the following factors: a size of an LCG ID space, a service type, a bear type, the number of LCGs for which the corresponding buffer status is to be reported to the network node, an amount of information for indicating buffer status of an LCG for which the corresponding buffer status is to be reported to the network node, an amount of radio resource available for the radio device, etc.

In accordance with some exemplary embodiments, the one or more candidate formats may comprise a first format (such as Format 0, Format 1 and/or Format 1x as described in connection with FIG. 3A) which is configurable to report buffer status of a single LCG by using at least one of: an extendible LCID field, an extendible LCG ID field, and an extendible buffer status field.

Alternatively or additionally, the one or more candidate formats may comprise a second format (such as Format 2, Format 2x and/or Format 2y as described in connection with FIG. 3B) which is configurable to report buffer status of up to a first number of LCGs by using at least one of: an extendible LCID field, up to the first number of extendible LCG ID fields, and up to the first number of extendible buffer status fields. The first number may be equal to or larger than two. Optionally, the second format may be configurable to allow that the number of the LCG ID fields in the BSR is equal to or larger than the number of the buffer status fields (e.g., the optional buffer size field in Format 2 or 2x). In the case that the number of the buffer status fields is reduced to be less than the number of the LCG ID fields, the resource overhead used for the BSR can be reduced.

Alternatively or additionally, the one or more candidate formats may comprise a third format (such as Format 3 as described in connection with FIG. 3C) which is configurable to report buffer status of up to a second number of LCGs by using at least one of: an extendible LCID field, up to the second number of status presence fields indicating for which LCGs the corresponding buffer status is reported or is not reported; and up to the second number of buffer status fields. According to an exemplary embodiment, the second number may be determined based at least in part on the maximum number of LCGs configured for the radio device. Optionally, the third format may be configurable to allow that the number of the status presence fields in the BSR is equal to or larger than the number of the buffer status fields. The resource overhead may be saved with decrease of the number of the buffer status fields (e.g., by reducing one or more buffer size fields in Format 3).

In accordance with some exemplary embodiments, the one or more candidate formats may be preconfigured for the radio device by the network node. Alternatively, the one or more candidate formats may be predefined locally at the radio device. Optionally, at least part of the one or more candidate formats may be coordinated by the network node and the radio device. According to an exemplary embodiment, some criteria or rules for selecting the BSR format among the one or more candidate formats may be provisioned by the radio device and/or the network node.

In accordance with an exemplary embodiment, there may be one or more candidate short BSR MAC CE formats and the radio device can determine which short BSR MAC CE format is used according to one or more of: the type of radio device/node, the LCID configuration, the LCG configuration and the maximum number of LCHs.

In accordance with an exemplary embodiment, there may be one or more candidate short BSR MAC CE formats and the radio device may be configured with which short BSR MAC CE format is used.

In accordance with an exemplary embodiment, there may be one or more candidate long or long truncated BSR MAC CE formats and the radio device can deter mine which long or long truncated BSR MAC CE format is used according to one or more of: the type of radio device/node, the LCID configuration, the LCG configuration and the maximum number of LCHs.

In accordance with an exemplary embodiment, there may be one or more candidate long or long truncated BSR MAC CE formats and the radio device may be configured with which short BSR MAC CE format is used.

In accordance with some exemplary embodiments, the triggering of the BSR may further comprise generating the BSR based at least in part on the selected format of the BSR and transmitting the BSR to the network node. In response that there is free radio resource available for reporting the buffer status of at least one of the one or more other LCGs, the radio device may indicate buffer status of the at least one of the one or more other LCGs in another BSR. Then the radio device can transmit the another BSR to the network node, for example, in a different control element from a control element (such as a BSR MAC CE) carrying the BSR. According to an exemplary embodiment, said another BSR may comprise a padding BSR in addition to a regular BSR.

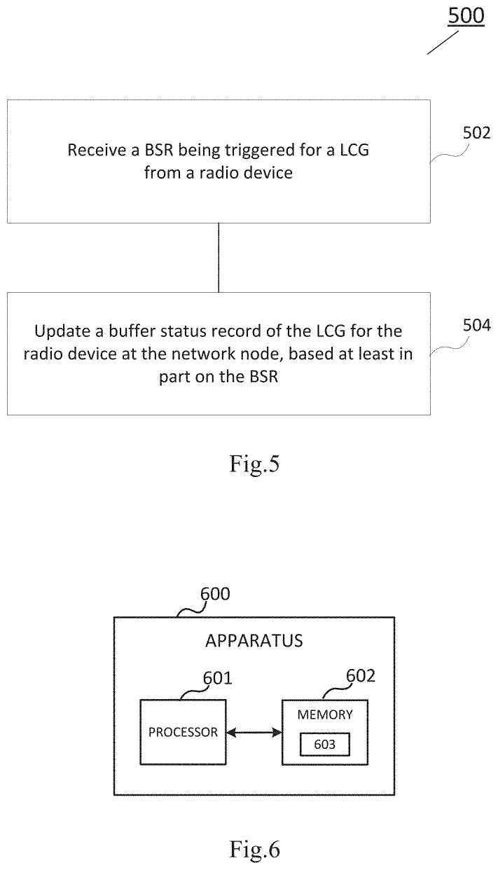

FIG. 5 is a flowchart illustrating another method 500 according to some embodiments of the present disclosure. The method 500 illustrated in FIG. 5 may be performed by a network node or an apparatus communicatively coupled to a network node. In accordance with an exemplary embodiment, the network node may comprise a base station (such as a NB, an AP, etc.). The network node can configure scheduling resources for a radio device as described with respect FIG. 4, to according to a BSR from the radio device.

According to the exemplary method 500 illustrated in FIG. 5, the network node may receive a BSR being triggered for an LCG from a radio device, as shown in block 502. The BSR indicates buffer status of the LCG for the radio device. As described in connection with FIG. 4, the BSR may be allowed not to indicate buffer status of one or more other LCGs for the radio device, for which LCGs no event occurs to trigger reporting of buffer status. In this way, the BSR may be triggered per LCG rather than per MAC entity. According to an exemplary embodiment, the BSR may be triggered by an event which is related to a BSR timer configured for the LCG, for example, being triggered by retxBSR-timer or periodicBSR-timer expiry.

Based at least in part on the BSR, the network node can update a buffer status record of the LCG for the radio device at the network node, as shown in block 504. In accordance with some exemplary embodiments, the network node can update the buffer status record by determining, based at least in part on the BSR, which of one or more candidate formats is a format of the BSR, and obtaining the buffer status indicated by the BSR to update the buffer status record, according to the determined format of the BSR. As described in connection with FIG. 4, the network node may preconfigure the one or more candidate formats for the radio device.

In accordance with some exemplary embodiments, the one or more candidate formats may comprise a first format for a single LCG, a second format for up to a first number of LCGs (e.g., one or more LCGs), a third format for up to a second number of LCGs (e.g., the maximum number of LCGs configurable to the radio device), or any combination thereof. Optionally, a candidate format (such as Format 0, 1, 1x, 2, 2x, 2y or 3 as shown in FIGS. 3A-3C) may be configured flexibly to make one or more fields have variable length, for example, by using one or more extended bits. Alternatively or additionally, the size of the candidate format may be decreased with reduction of one or more optional fields.

In accordance with some exemplary embodiments, the BSR may indicate buffer status of at least one of the one or more other LCGs for which no BSR trigger event occurs. In this case, the network node can update a buffer status record of the at least one of the one or more other LCGs for the radio device at the network node, based at least in part on the BSR.

Optionally, the network node may receive, from the radio device, another BSR in a different control element (such as a BSR MAC CE) from a control element carrying the BSR. The another BSR may indicate buffer status of at least one of the one or more other LCGs. Based at least in part on the another BSR, the network node can update a buffer status record of the at least one of the one or more other LCGs for the radio device at the network node.

The proposed solution according to one or more exemplary embodiments can enable a radio device (such as a UE, an IAB-N, a NB, a relay node, etc.) to selectively report buffer status for one or more LCGs, for example, only for those LCGs having triggered BSR events, so that the radio device can save radio resource and improve transmission efficiency. On the other hand, the radio device according to the proposed solution can adaptively select or determine a proper BSR format (e.g., a short BSR or a long/long truncated BSR) to report buffer status of one or more LCGs to a network node (such as a gNB or an AP). The flexible configuration of the BSR format, for example, by saving some bytes in the BSR, can further enhance resource utilization.

The various blocks shown in FIGS. 4-5 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

FIG. 6 is a block diagram illustrating an apparatus 600 according to various embodiments of the present disclosure. As shown in FIG. 6, the apparatus 600 may comprise one or more processors such as processor 601 and one or more memories such as memory 602 storing computer program codes 603. The memory 602 may be non-transitory machine/processor/computer readable storage medium. In accordance with some exemplary embodiments, the apparatus 600 may be implemented as an integrated circuit chip or module that can be plugged or installed into a radio device as described with respect to FIG. 4, or a network node as described with respect to FIG. 5. In such case, the apparatus 600 may be implemented as a radio device as described with respect to FIG. 4, or a network node as described with respect to FIG. 5.

In some implementations, the one or more memories 602 and the computer program codes 603 may be configured to, with the one or more processors 601, cause the apparatus 600 at least to perform any operation of the method as described in connection with FIG. 4. In other implementations, the one or more memories 602 and the computer program codes 603 may be configured to, with the one or more processors 601, cause the apparatus 600 at least to perform any operation of the method as described in connection with FIG. 5.

Alternatively or additionally, the one or more memories 602 and the computer program codes 603 may be configured to, with the one or more processors 601, cause the apparatus 600 at least to perform more or less operations to implement the proposed methods according to the exemplary embodiments of the present disclosure.

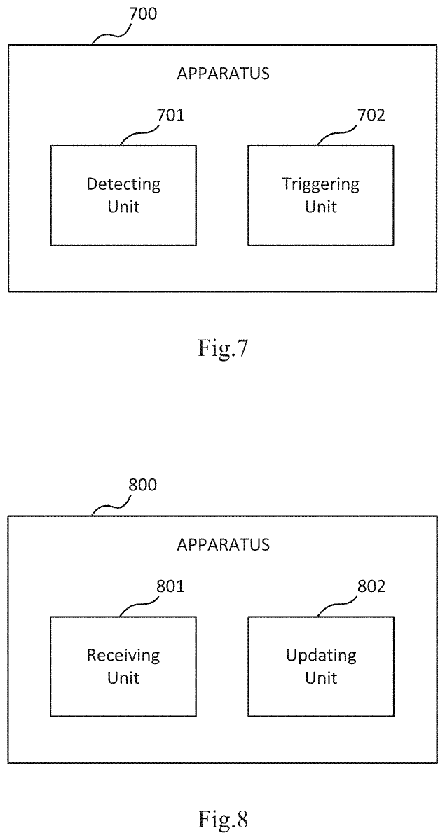

FIG. 7 is a block diagram illustrating an apparatus 700 according to some embodiments of the present disclosure. The apparatus 700 may be implemented as a radio device or as a part of the radio device. As shown in FIG. 7, the apparatus 700 may comprise a detecting unit 701 and a triggering unit 702. In an exemplary embodiment, the apparatus 700 may be implemented in a radio device such as a UE, an IAB-N, a NB, a relay node, a transmission point, etc. The detecting unit 701 may be operable to carry out the operation in block 402, and the triggering unit 702 may be operable to carry out the operation in block 404. Optionally, the detecting unit 701 and/or triggering unit 702 may be operable to carry out more or less operations to implement the proposed methods according to the exemplary embodiments of the present disclosure.

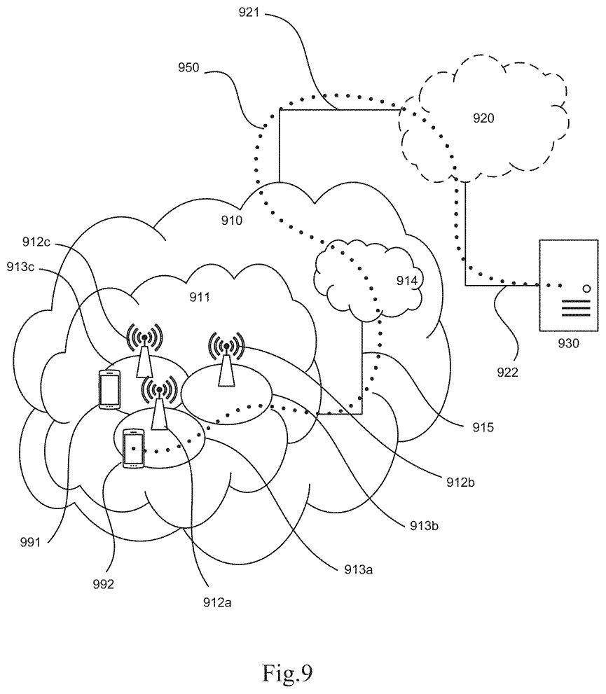

FIG. 8 is a block diagram illustrating an apparatus 800 according to some embodiments of the present disclosure. The apparatus 800 may be implemented as a network node or as a part of the network node. As shown in FIG. 8, the apparatus 800 may comprise a receiving unit 801 and an updating unit 802. In an exemplary embodiment, the apparatus 800 may be implemented in a network node such as a gNB, an AP, etc. The receiving unit 801 may be operable to carry out the operation in block 502, and the updating unit 802 may be operable to carry out the operation in block 504. Optionally, the receiving unit 801 and/or the updating unit 802 may be operable to carry out more or less operations to implement the proposed methods according to the exemplary embodiments of the present disclosure.

FIG. 9 is a block diagram illustrating a telecommunication network connected via an intermediate network to a host computer in accordance with sonic embodiments of the present disclosure.

With reference to FIG. 9, in accordance with an embodiment, a communication system includes a telecommunication network 910, such as a 3GPP-type cellular network, which comprises an access network 911, such as a radio access network, and a core network 914. The access network 911 comprises a plurality of base stations 912a, 912b, 912c, such as NBs, eNBs, gNBs or other types of wireless access points, each defining a corresponding coverage area 913a, 913b, 913c. Each base station 912a, 912b, 912c is connectable to the core network 914 over a wired or wireless connection 915. A first UE 991 located in a coverage area 913c is configured to wirelessly connect to, or be paged by, the corresponding base station 912c. A second UE 992 in a coverage area 913a is wirelessly connectable to the corresponding base station 912a. While a plurality of UEs 991, 992 are illustrated in this example, the disclosed embodiments are equally applicable to a situation where a sole UE is in the coverage area or where a sole UE is connecting to the corresponding base station 912.

The telecommunication network 910 is itself connected to a host computer 930, which may be embodied in the hardware and/or software of a standalone server, a cloud-implemented server, a distributed server or as processing resources in a server farm. The host computer 930 may be under the ownership or control of a service provider, or may be operated by the service provider or on behalf of the service provider. Connections 921 and 922 between the telecommunication network 910 and the host computer 930 may extend directly from the core network 914 to the host computer 930 Or may go via an optional intermediate network 920. An intermediate network 920 may be one of, or a combination of more than one of, a public, private or hosted network; the intermediate network 920, if any, may be a backbone network or the Internet; in particular, the intermediate network 920 may comprise two or more sub-networks (not shown).

The communication system of FIG. 9 as a whole enables connectivity between the connected UEs 991, 992 and the host computer 930. The connectivity may be described as an over-the-top (OTT) connection 950. The host computer 930 and the connected UEs 991, 992 are configured to communicate data and/or signaling via the OTT connection 950, using the access network 911, the core network 914, any intermediate network 920 and possible further infrastructure (not shown) as intermediaries. The OTT connection 950 may be transparent in the sense that the participating communication devices through which the OTT connection 950 passes are unaware of routing of uplink and downlink communications. For example, the base station 912 may not or need not be informed about the past routing of an incoming downlink communication with data originating from the host computer 930 to be forwarded (e.g., handed over) to a connected UE 991. Similarly, the base station 912 need not be aware of the future routing of an outgoing uplink communication originating from the UE 991 towards the host computer 930.

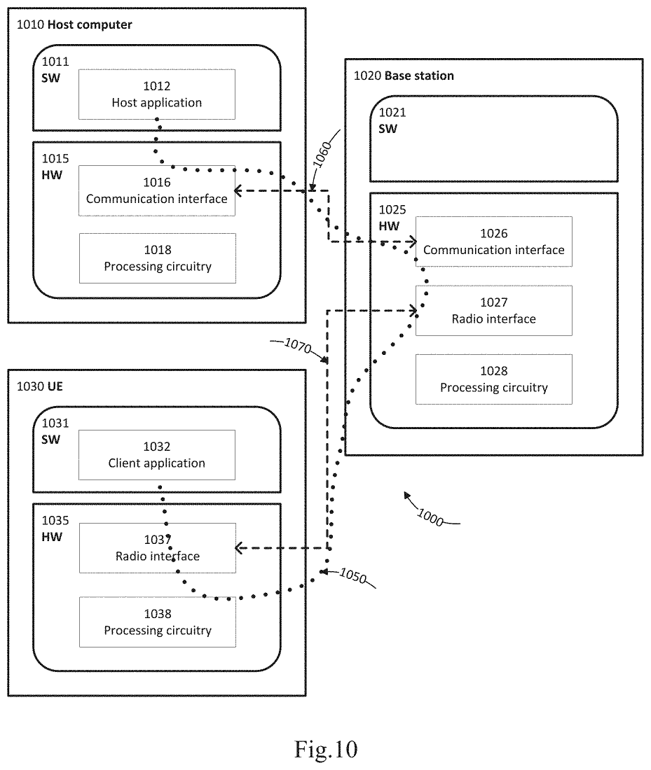

FIG. 10 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 10. In a communication system 1000, a host computer 1010 comprises hardware 1015 including a communication interface 1016 configured to set up and maintain a wired or wireless connection with an interface of a different communication device of the communication system 1000. The host computer 1010 further comprises a processing circuitry 1018, which may have storage and/or processing capabilities. In particular, the processing circuitry 1018 may comprise one or more programmable processors, application-specific integrated circuits, field programmable gate arrays or combinations of these (not shown) adapted to execute instructions. The host computer 1010 further comprises software 1011, which is stored in or accessible by the host computer 1010 and executable by the processing circuitry 1018. The software 1011 includes a host application 1012. The host application 1012 may be operable to provide a service to a remote user, such as UE 1030 connecting via an OTT connection 1050 terminating at the UE 1030 and the host computer 1010. In providing the service to the remote user, the host application 1012 may provide user data which is transmitted using the OTT connection 1050.

The communication system 1000 further includes a base station 1020 provided in a telecommunication system and comprising hardware 1025 enabling it to communicate with the host computer 1010 and with the UE 1030. The hardware 1025 may include a communication interface 1026 for setting up and maintaining a wired or wireless connection with an interface of a different communication device of the communication system 1000, as well as a radio interface 1027 for setting up and maintaining at least a wireless connection 1070 with the UE 1030 located in a coverage area (not shown in FIG. 10) served b the base station 1020. The communication interface 1026 may be configured to facilitate a connection 1060 to the host computer 1010. The connection 1060 may be direct or it may pass through a core network (not shown in FIG. 10) of the telecommunication system and/or through one or more intermediate networks outside the telecommunication system. In the embodiment shown, the hardware 1025 of the base station 1020 further includes a processing circuitry 1028, which may comprise one or more programmable processors, application-specific integrated circuits, field programmable gate arrays or combinations of these (not shown) adapted to execute instructions. The base station 1020 further has software 1021 stored internally or accessible via an external connection.

The communication system 1000 further includes the UE 1030 already referred to. Its hardware 1035 may include a radio interface 1037 configured to set up and maintain a wireless connection 1070 with a base station serving a coverage area in which the UE 1030 is currently located. The hardware 1035 of the UE 1030 further includes a processing circuitry 1038, which may comprise one or more programmable processors, application-specific integrated circuits, field programmable gate arrays or combinations of these (not shown) adapted to execute instructions. The UE 1030 further comprises software 1031, which is stored in or accessible by the UE 1030 and executable by the processing circuitry 1038. The software 1031 includes a client application 1032. The client application 1032 may be operable to provide a service to a human or non-human user via the UE 1030, with the support of the host computer 1010. In the host computer 1010, an executing host application 1012 may communicate with the executing client application 1032 via the OTT connection 1050 terminating at the UE 1030 and the host computer 1010. In providing the service to the user, the client application 1032 may receive request data from the host application 1012 and provide user data in response to the request data. The OTT connection 1050 may transfer both the request data and the user data. The client application 1032 may interact with the user to generate the user data that it provides.

It is noted that the host computer 1010, the base station 1020 and the UE 1030 illustrated in FIG. 10 may be similar or identical to the host computer 930, one of base stations 912a, 912b, 912c and one of UEs 991, 992 of FIG. 9, respectively. This is to say, the inner workings of these entities may be as shown in FIG. 10 and independently, the surrounding network topology may be that of FIG. 9.

In FIG. 10, the OTT connection 1050 has been drawn abstractly to illustrate the communication between the host computer 1010 and the UE 1030 via the base station 1020, without explicit reference to any intermediary devices and the precise routing of messages via these devices. Network infrastructure may determine the routing, which it may be configured to hide from the UE 1030 or from the service provider operating the host computer 1010, or both. While the OTT connection 1050 is active, the network infrastructure may further take decisions by which it dynamically changes the routing (e.g., on the basis of load balancing consideration or reconfiguration of the network).

Wireless connection 1070 between the UE 1030 and the base station 1020 is in accordance with the teachings of the embodiments described throughout this disclosure. One or more of the various embodiments improve the performance of OTT services provided to the UE 1030 using the OTT connection 1050, in which the wireless connection 1070 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 1050 between the host computer 1010 and the UE 1030, in response to variations in the measurement results. The measurement procedure and/or the network functionality for reconfiguring the OTT connection 1050 may be implemented in software 1011 and hardware 1015 of the host computer 1010 or in software 1031 and hardware 1035 of the UE 1030, or both. In embodiments, sensors (not shown) may be deployed in or in association with communication devices through which the OTT connection 1050 passes; the sensors may participate in the measurement procedure by supplying values of the monitored quantities exemplified above, or supplying values of other physical quantities from which the software 1011, 1031 may compute or estimate the monitored quantities. The reconfiguring of the OTT connection 1050 may include message format, retransmission settings, preferred routing etc.; the reconfiguring need not affect the base station 1020, and it may be unknown or imperceptible to the base station 1020. Such procedures and functionalities may be known and practiced in the art. In certain embodiments, measurements may involve proprietary UE signaling facilitating the host computer 1010's measurements of throughput, propagation times, latency and the like. The measurements may be implemented in that the software 1011 and 1031 causes messages to be transmitted, in particular empty or ‘dummy’ messages, using the OTT connection 1050 while it monitors propagation times, errors etc.

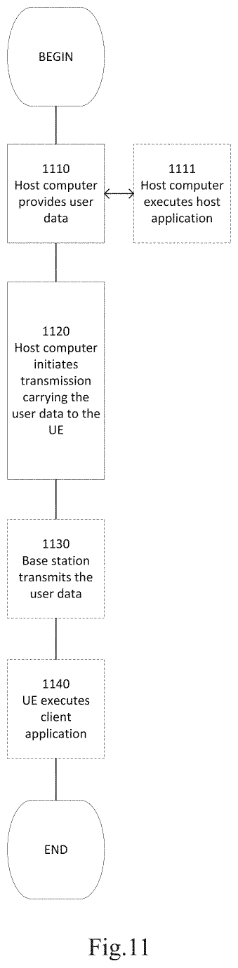

FIG. 11 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 11 will be included in this section. In step 1110, the host computer provides user data. In substep 1111 (which may be optional) of step 1110, the host computer provides the user data by executing a host application. In step 1120, the host computer initiates a transmission carrying the user data to the UE. In step 1130 (which may be optional), the base station transmits to the UE the user data which was carried in the transmission that the host computer initiated, in accordance with the teachings of the embodiments described throughout this disclosure. In step 1140 (which may also be optional), the UE executes a client application associated with the host application executed by the host computer.

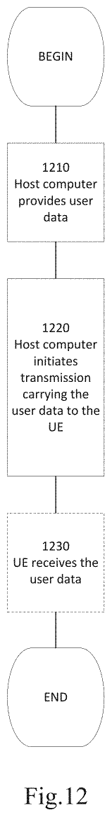

FIG. 12 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 12 will be included in this section. In step 1210 of the method, the host computer provides user data. In an optional substep (not shown) the host computer provides the user data by executing a host application. In step 1220, the host computer initiates a transmission carrying the user data to the UE. The transmission may pass via the base station, in accordance with the teachings of the embodiments described throughout this disclosure. In step 1230 (which may be optional), the UE receives the user data carried in the transmission.

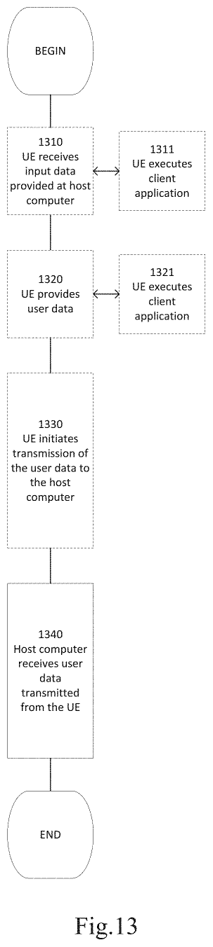

FIG. 13 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 13 will be included in this section. In step 1310 (which may be optional), the UE receives input data provided by the host computer. Additionally or alternatively, in step 1320, the UE provides user data. In substep 1321 (which may be optional) of step 1320, the UE provides the user data by executing a client application. In substep 1311 (which may be optional) of step 1310, the UE executes a client application which provides the user data in reaction to the received input data provided by the host computer. In providing the user data, the executed client application may further consider user input received from the user. Regardless of the specific manner in which the user data was provided, the UE initiates, in substep 1330 (which may be optional), transmission of the user data to the host computer. In step 1340 of the method, the host computer receives the user data transmitted from the UE, in accordance with the teachings of the embodiments described throughout this disclosure.

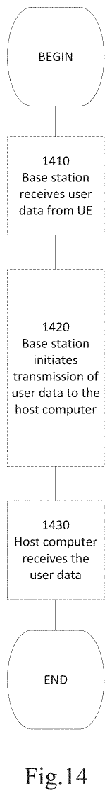

FIG. 14 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 14 will be included in this section. In step 1410 (which may be optional), in accordance with the teachings of the embodiments described throughout this disclosure, the base station receives user data from the UE. In step 1420 (which may be optional), the base station initiates transmission of the received user data to the host computer. In step 1430 (which may be optional), the host computer receives the user data carried in the transmission initiated by the base station.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A method performed by a radio device, comprising:
detecting a trigger event of reporting buffer status of a logical channel group for the radio device to a network node; and
triggering a buffer status report indicating the buffer status of the logical channel group, in response to the detected trigger event, wherein the buffer status report is allowed not to indicate buffer status of one or more other logical channel groups for the radio device, for which logical channel groups no event occurs to trigger reporting of buffer status.

2. The method according to claim 1, further comprising:
indicating buffer status of at least one of the one or more other logical channel groups in the buffer status report, in response that there is free radio resource available for reporting the buffer status of the at least one of the one or more other logical channel groups.

3. The method according to claim 1, wherein the triggering of the buffer status report comprises selecting, from one or more candidate formats, a format of the buffer status report based at least in part on at least one of:
a size of a logical channel group identifier space;
a service type;
a bear type;
a number of logical channel groups for which the corresponding buffer status is to be reported to the network node;
an amount of information for indicating buffer status of a logical channel group for which the corresponding buffer status is to be reported to the network node; and
an amount of radio resource available for the radio device.

4. The method according to claim 3, wherein the one or more candidate formats comprise a first format which is configurable to report buffer status of a single logical channel group by using at least one of:
an extendible logical channel identifier field;
an extendible logical channel group identifier field; and
an extendible buffer status field.

5. The method according to claim 3, wherein the one or more candidate formats comprise a second format which is configurable to report buffer status of up to a first number of logical channel groups by using at least one of:
an extendible logical channel identifier field;
up to the first number of extendible logical channel group identifier fields; and
up to the first number of extendible buffer status fields, and wherein the first number is equal to or larger than two.

6. The method according to claim 5, wherein the second format is configurable to allow that a number of the logical channel group identifier fields in the buffer status report is equal to or larger than a number of the buffer status fields.

7-11. (canceled)

12. The method according to claim 1, further comprising:
indicating buffer status of at least one of the one or more other logical channel groups in another buffer status report, in response that there is free radio resource available for reporting the buffer status of the at least one of the one or more other logical channel groups; and
transmitting to the network node the another buffer status report in a different control element from a control element carrying the buffer status report.

13. The method according to claim 1, wherein the radio device comprises one of a terminal device, an integrated access backhaul node, a node B, a transmission point, and a relay node.

14-27. (canceled)

28. A network node, comprising:
one or more processors; and
one or more memories comprising computer program codes,
the one or more memories and the computer program codes configured to, with the one or more processors, cause the network node at least to:
receive, from a radio device, a buffer status report being triggered for a logical channel group for the radio device, wherein the buffer status report indicates buffer status of the logical channel group; and
update a buffer status record of the logical channel group for the radio device at the network node, based at least in part on the buffer status report, wherein the buffer status report is allowed not to indicate buffer status of one or more other logical channel groups for the radio device, for which logical channel groups no event occurs to trigger reporting of buffer status.

29-30. (canceled)

31. The network node according to claim 28, wherein the one or more memories and the computer program code that causes the network node to update the buffer status record is configured to, with the one or more processors, cause the network node to:
determine which of one or more candidate formats is a format of the buffer status report, based at least in part on the buffer status report; and
obtain the buffer status indicated by the buffer status report to update the buffer status record, according to the determined format of the buffer status report.

32. The network node according to claim 31, wherein the one or more candidate formats comprise a first format which is configurable to report buffer status of a single logical channel group by using at least one of:
an extendible logical channel identifier field;
an extendible logical channel group identifier field; and
an extendible buffer status field.

33. The network node according to claim 31, wherein the one or more candidate formats comprise a third format which is configurable to report buffer status of up to a second number of logical channel groups by using at least one of:
an extendible logical channel identifier field;
up to the second number of status presence fields indicating for which logical channel groups the corresponding buffer status is reported or is not reported; and
up to the second number of buffer status fields, and
wherein the second number is determined based at least in part on a maximum number of logical channel groups configured for the radio device.

34. The network node according to claim 33, wherein the third format is configurable to allow that a number of the status presence fields in the buffer status report is equal to or larger than a number of the buffer status fields.

35. The network node according to claim 28, wherein the one or more memories and the computer program code are configured to, with the one or more processors, cause the network node to:
receive, from the radio device, another buffer status report in a different control element from a control element carrying the buffer status report, wherein the another buffer status report indicates buffer status of at least one of the one or more other logical channel groups; and
update a buffer status record of the at least one of the one or more other logical channel groups for the radio device at the network node, based at least in part on the another buffer status report.

36. A radio device, comprising:
one or more processors; and
one or more memories comprising computer program codes,
the one or more memories and the computer program codes configured to, with the one or more processors, cause the radio device at least to:
detect a trigger event of reporting buffer status of a logical channel group for the radio device to a network node; and
trigger a buffer status report indicating the buffer status of the logical channel group, in response to the detected trigger event, wherein the buffer status report is allowed not to indicate buffer status of one or more other logical channel groups for the radio device, for which logical channel groups no event occurs to trigger reporting of buffer status.

37. The radio device of claim 36, wherein the one or more memories and the computer program codes configured to, with the one or more processors, cause the radio device at least to:
indicate buffer status of at least one of the one or more other logical channel groups in the buffer status report, in response that there is free radio resource available for reporting the buffer status of the at least one of the one or more other logical channel groups.

38. The radio device of claim 36, wherein the one or more memories and the computer program codes configured to, with the one or more processors, cause the radio device to trigger the buffer status report are further configured to cause the radio device to:
select, from one or more candidate formats, a format of the buffer status report based at least in part on at least one of:
a size of a logical channel group identifier space;
a service type;
a bear type;
a number of logical channel groups for which the corresponding buffer status is to be reported to the network node;
an amount of information for indicating buffer status of a logical channel group for which the corresponding buffer status is to be reported to the network node; and
an amount of radio resource available for the radio device.

39. The radio device of claim 38, wherein the one or more candidate formats comprise a first format which is configurable to report buffer status of a single logical channel group by using at least one of:
an extendible logical channel identifier field;
an extendible logical channel group identifier field; and
an extendible buffer status field.

40. The radio device of claim 38, wherein the one or more candidate formats comprise a second format which is configurable to report buffer status of up to a first number of logical channel groups by using at least one of:
an extendible logical channel identifier field;
up to the first number of extendible logical channel group identifier fields; and
up to the first number of extendible buffer status fields, and
wherein the first number is equal to or larger than two.

41. The radio device of claim 40, wherein the second format is configurable to allow that a number of the logical channel group identifier fields in the buffer status report is equal to or larger than a number of the buffer status fields.

42. The radio device of claim 36, wherein the one or more memories and the computer program codes configured to, with the one or more processors, cause the radio device at least to:
indicate buffer status of at least one of the one or more other logical channel groups in another buffer status report, in response that there is free radio resource available for reporting the buffer status of the at least one of the one or more other logical channel groups; and
transmit to the network node the another buffer status report in a different control element from a control element carrying the buffer status report.

43. The radio device of claim 36, wherein the radio device comprises one of a terminal device, an integrated access backhaul node, a node B, a transmission point, and a relay node.
